(19) United States
(12) Patent Application Publication
(10) Pub. No.: US 2005/0259979 A1
(43) Pub. Date: Nov. 24, 2005

(54) DVD reproduction method and device

(76) Inventor: Michael Huebner, Garbsen (DE)

Correspondence Address: KENYON & KENYON, ONE BROADWAY, NEW YORK, NY, 10004, US

(21) Appl. No.: 11/126,048

(22) Filed: May 9, 2005

(30) Foreign Application Priority Data
May 10, 2004 (DE) 102004023005.6

(51) Int. Cl. H04N 5/781

(52) U.S. Cl. 386/125; 386/126

(57) ABSTRACT

A DVD reproduction method and a DVD reproduction device in which, by switchover of the image data flow in response to the presence of a safety criterion, the display of a fixed image from a prespecified region of the image memory takes place.

### BACKGROUND INFORMATION

In recent times, the medium DVD (digital versatile disk) has generally established itself on the market, and is used by a number of products. In particular, DVD is also entering the motor vehicle field, whereby newly posed technical problems result. Because of the increased storage capacity compared to the CD (compact disk), DVD is ideally suited for motor vehicle applications. In this context, the use of the DVD is not limited only to the storage of data, such as for motor vehicle navigation, but is also used for playing video media, that is, for the reproduction of moving pictures and sounds for entertainment purposes.

FIG. 1 shows a block diagram of a DVD reproduction device in a motor vehicle. The DVD reproduction device, or the DVD player is here marked as 1. Reproduction device 1 includes a DVD disk drive 20 for reading the DVD, a decoding device 30 for removing the coding and an intermediate storage device 40 for the intermediate storage of the DVD data. The intermediate storage device 40 is connected to a video decoder 60, an insert decoder 70 and an audio decoder 50. The DVD data are supplied at the output of intermediate storage device 40, and made available to the decoders named. Video decoder 60 decodes, or rather decompresses the moving video data and outputs the decoded, or rather the decompressed video data. In this context, decoder 60 is usually an MPEG decoder. If other coding or compressing algorithms are used, this decoder or decompressor is adjusted to this algorithm. Insert decoder 70 decodes or decompresses an inserts or subpicture data flow that is contained in the DVD data flow, and gives outputs it. Audio decoder 50 decodes or decompresses audio data that are contained in the DVD data flow. Audio decoder 50 is linked to a loudspeaker 110 which reproduces the decoded or decompressed audio data. Decoders 60 and 70 are connected to an image memory 80. The decoded or decompressed video data (from decoder 60) and the corresponding insert data (from decoder 70) are passed on to this image memory 80. There they are stored and read out by a video controller 90. The latter fits the moving video data and the insert data together, and generates a screen display for screen 100. Image memory 80 is also used for the intermediate storage of the image data during decoding.

Finally, reproduction device 1 includes a control unit 10, which implements the disk navigation, the disk drive control and the general sequencing control. This is expressed by arrows which indicate various control signals, here not specified in detail, for the individual components of reproduction device 1.

A DVD usually includes three different types of data flows, namely video data flows having moving video images, audio data flows and insert data flows, the insert data flows being generally used for subtitling and for user guidance (user interface). In this context, the user interface may be designed by the manufacturer individually for each individual DVD. Whereas subtitling of a DVD may always be suppressed, video and audio data as well as the user interface are usually coupled to one another by specification of the manufacturer.

The reproduction of sound during automobile travel is generally thought to be unobjectionable. The same applies to the reproduction of subpicture information texts and navigation map representations. By contrast, the reproduction of moving pictures during an automobile trip should be regarded as critical, since the driver of the motor vehicle may be distracted by the movement, even if the image reproduction is meant only for the entertainment of the passengers. That is why the reproduction of moving images is prohibited in some countries.

German Patent Application No. DE 100 65 624 therefore shows a procedure with the aid of which reproduction of moving images is suppressed when the vehicle is moving. The way this is done is that, when the vehicle is moving, the reception of DVD data by the MPEG decoder is stopped, and instead wallpaper data are applied to the input of the decoder or the display device.

### SUMMARY OF THE INVENTION

By switching over the display to one or more fixed images (as contrasted to moving images) when there is the so-called safety signal, which indicates that moving images in the motor vehicle are not expedient, it is achieved that the viewer, particularly the motor vehicle driver, is not distracted by the moving images of the DVD during the trip. In this context, in an advantageous manner, the functional units taking part in the reproduction of the DVD continue to be operated, or rather, the decoded or decompressed DVD data flow is rerouted. In this way it is possible, besides the reproduction of fixed images, possibly also to reproduce audio data as well as additional image information. Thus it is possible, for example, to display insert or subpicture information.

In an advantageous way, it is also possible for the user to control the DVD reproduction device by using the user interface stored on the DVD, since displaying the subpicture information becomes possible on the display unit.

It is particularly advantageous that the decision on the activation of the switchover is made by a control software, and can consequently be made a function of any influential variables. Therefore, the switchover may be a function of external and of internal influential variables. An example of such an external influential variable is a motor vehicle parameter such as detecting the start of the engine, detecting the stopping of the engine, movement of the vehicle, the setting of the transmission into a travel setting and/or the detachment of the hand brake or shifting out of the park setting in an automatic transmission.

Particularly advantageous is the fitting in of an additional video controller, with the aid of which it becomes possible not to stop the reproduction of moving images at other monitors in the motor vehicle, but, for instance, to give the passengers on the back seats the possibility of looking at moving images even during the trip. In this way, the DVD reproduction device is adapted to the special requirements of motor vehicle application in an optimal manner, since the reproduction of the moving images is only stopped when the reproduction considerably impairs the attention of the driver and possibly the front passenger.

### BRIEF DESCRIPTION OF THE DRAWINGS

FIG. 1 illustrates a block diagram of a DVD player.

FIG. 2 shows a flow chart that represents an algorithm, with the aid of which, in those operating ranges in which the reproduction of moving images in the motor vehicle is undesired, reproducing fixed images is possible, this problem solution being usable with all DVD titles currently on the market, even those without subpictrure information.

FIG. 3 shows a block diagram of a DVD player in which, by additional measures, the display of moving images is made possible only at selected display units, while at others fixed images are reproduced.

### DETAILED DESCRIPTION

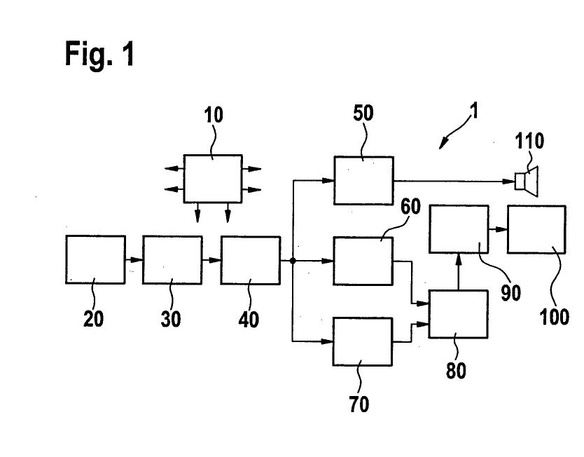

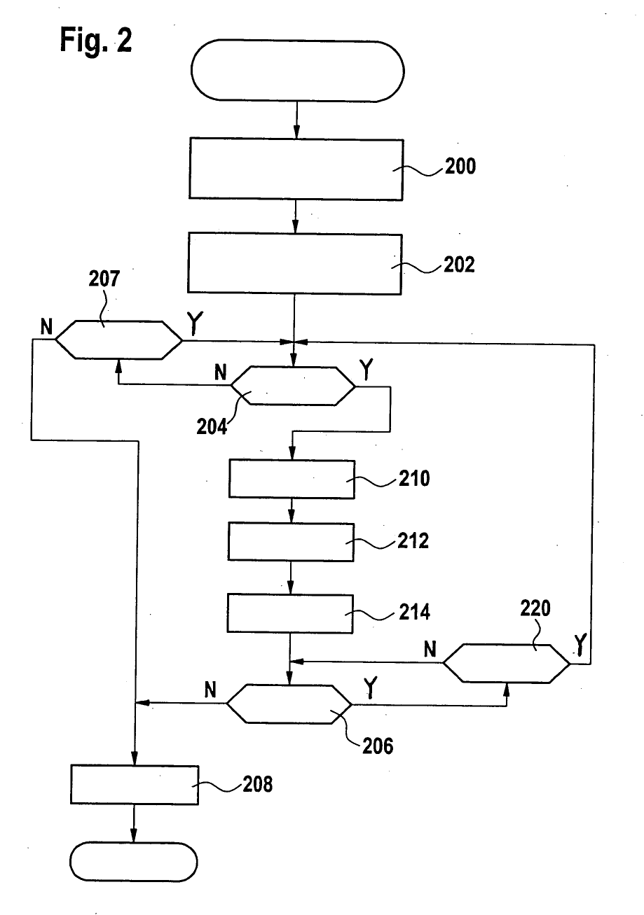

FIG. 2 shows a flow chart that sketches an algorithm with the aid of which the DVD data flow is diverted under certain circumstances, and possibly is able to be replaced by a fixed image. The important thing is that this functions without access to the subpicture information, which is not made available by all DVD titles that are currently on the market. The sequence sketched in FIG. 2 represents the outline of a software program that runs in the control unit. The program shown is initiated when a so-called safety criterion is satisfied, or an appropriate signal is present. When such a safety signal is present, no more moving images are to be shown on the display, at least the one in the driver's area and in some applications also in the front passenger area. The safety signal is formed, in this context, when the driver of the motor vehicle has to direct his attention to the driving action, thus, particularly when the motor vehicle is moving. Examples of such criteria were named above. If such a safety signal is present, only one or several fixed images are shown on the display in the driver's or the front passenger's area. The DVD data flow of moving images for display is diverted. What is important is that all functional units (see FIG. 1, 10 to 110) that have a role in the DVD reproduction work the same as during normal reproduction.

If a safety signal is present, the program sketched in FIG. 2 is initiated. In first step 200, the data transfer from is diverted by MPEG decoder 60 in such a way that this data flow is written into a data area A of image memory 80. In this context, data area A is not shown on the display, since video controller 90 accesses another data area of the memory. In subsequent step 202, the video controller reads the fixed image to be read out from a separate area B of image memory 80.

Thus, as soon as at least one of the safety criteria named is present, the data transfer is diverted from the MPEG decoder to another memory area, which is not accessed by video controller 90 for the purpose of display, and video controller 90 reads out a fixed image from an area of the image memory provided for this, and puts this fixed image on display. In other words, reproduction of moving images on the display is stopped thereby, and replaced by a fixed image or several fixed images (which change in the corresponding data area of the image memory).

In the next step 204 a check is made as to whether a menu is just being represented. The representation of a menu by the DVD player is determined based on the navigation data of the DVD player, namely if access is made to an area of the DVD in which menu information is stored. If, at the moment, no menu is being shown, the system waits in a loop until the DVD player enters a menu. In this context, the safety criterion is constantly checked, in order to be able to return directly to normal operation (step 208) if the safety criterion is no longer being satisfied (step 207).

If the representation of a menu was detected in step 204, in step 210 the system waits for a specified time period T0. After the expiration of this time period, in step 212 the current full-frame display of MPEG decoder 60 is transmitted to area B of the image memory (screen shot) that was reserved for the reproduction of the fixed image. Then, in step 214, the image stored in the fixed image area of the image memory is displayed.

As an alternative to this, area A of the MPEG decoder, that is reserved for writing, and area B, that is reserved for reading out and displaying the data, are exchanged, that is, from now on, the writing of the data is transferred from the MPEG decoder to area B, and the reading and display of the data out of area A. Which solution comes in useful for the screen shot in step 212 depends on the hardware that is available for the implementation.

Thereafter, in an additional loop (206, 220) it is checked whether the safety criterion is still satisfied or whether a status change has come about. A status change of the DVD player may come about, for example, by the press of a key, if an operator undertakes a change in status of the player. As long as such changes are not detected, it is checked constantly in step 206 whether the safety criterion is still present. As long as this is the case, the display of the fixed image in the storage area provided is continued.

If the safety criterion is no longer present, the system returns in step 206 to normal operation 208 of the player and leaves the program sketched in FIG. 2. In the case of a status change, the system returns in step 220 to querying menu information 204, and waits there again in loop 204, 207 until the DVD player has entered into a (new) menu. Thereafter, the whole procedure repeats itself using the steps 210, 212, 214, 206 and 220.

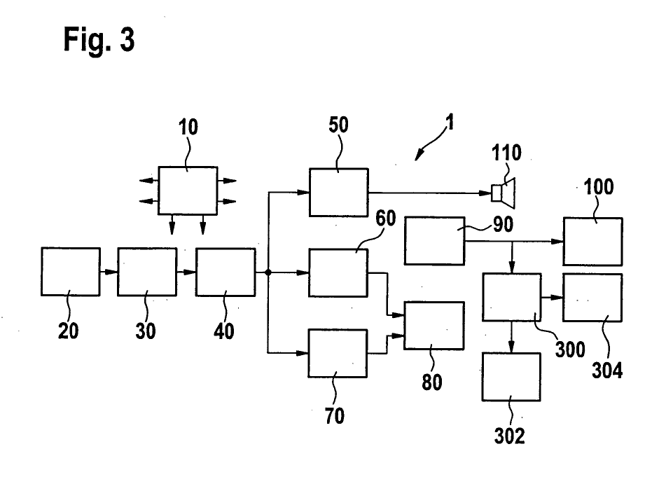

The solution described interrupts the reproduction of fixed images at all screens in the vehicle when the safety criterion is present. FIG. 3 describes a solution according to which only selected display units are switched over from moving image reproduction to fixed image reproduction when a safety criterion is present. In this context, following FIG. 1, FIG. 3 shows a block diagram of a DVD player, the blocks described for FIG. 1 being provided with the same reference numerals, and fulfilling the same functions as described with the aid of FIG. 1.

An important addition to the DVD player of FIG. 1 is an additional video controller 300 and an additional image memory 302 that is connected to video controller 300. In this context, selected displays 304 (screens) are connected to video controller 300, especially in the area of the front seats, whereas video controller 90 has display units 100 connected to it for the back seats. This solution may be implemented using any graphics accelerator that is on the market and has a live video input. The output of video controller 300 is connected to the output of controller 90. Video controller 300 communicates with image memory 302 and emits signals for display to display units 304.

In normal operation, the moving images are displayed on the display units of the back seats via video controller 90 and on display unit(s) (304) of the front seats via video controller 300. As shown above, if a safety criterion is present, the screen shot function is triggered by control computer 10 in a corresponding manner, and the data flow of the moving images is rerouted to a memory area which video controller 300 does not access for reproduction. A corresponding fixed image is loaded into image memory 302, or rather is entered there to the memory locations provided for image reproduction. Video controller 300 then shows this fixed image on monitor(s) 304 for the front seats, while the original moving image is present at the output of first video controller 90 and is reproduced at the display units for the rear seats.

1. A DVD reproduction method comprising:
stopping a display of moving images when at least one safety criterion is present; and
in the presence of at least one safety criterion, performing a switchover of a DVD data flow, and bringing a fixed image to display from a predetermined area of an image memory of a DVD player.

2. The method according to claim 1, wherein the method is performed in a motor vehicle.

3. The method according to claim 1, wherein the switchover of the DVD data flow, and of data transfers from an MPEG decoder, is performed in a data area of the image memory that is not brought to display on a screen.

4. The method according to claim 1, further comprising, when a menu is shown by the DVD player and when at least one safety criterion is present, transmitting a full-frame display to an area reserved for a fixed-image reproduction.

5. The method according to claim 4, wherein the transmission takes place upon expiration of a specified time period after a detection that a menu is being shown.

6. The method according to claim 1, further comprising, upon status changes of the DVD player and a subsequent showing of a menu by the DVD player, repeating a transmission of a current full-frame display into an area reserved for a reproduction of the fixed image.

7. The method according to claim 2, further comprising undertaking a fixed image reproduction, in the case where at least one safety criterion is present, only in the case of a selected number of screens, in a front region of the vehicle, whereas at other screens an output of moving images continues to take place.

8. A DVD reproduction device comprising:
a video controller for reading decoded image data out of an image memory and for displaying the data on a display unit, the video controller reading out onto the display unit a fixed image from a predetermined area of the image memory when a safety criterion is present, and displaying the fixed image.

9. The device according to claim 8, further comprising a further video controller for displaying, in response to the presence of a safety criterion, a fixed image at a selected number of display units in a motor vehicle, while the video controller displays moving images at other display units.
